(19) United States
(12) Patent Application Publication
(10) Pub. No.: US 2025/0329178 A1
(43) Pub. Date: Oct. 23, 2025

(54) Automatic Annotation of Data for Machine Learning

(71) Applicant: Ag Leader Technology, Inc., Ames, IA (US)

(72) Inventors: Trent Anagnostopoulos, Ankeny, IA (US); Josue Calderon, Apex, NC (US)

(73) Assignee: Ag Leader Technology, Inc., Ames, IA (US)

(21) Appl. No.: 19/184,544

(22) Filed: Apr. 21, 2025

Related U.S. Application Data
(60) Provisional application No. 63/637,605, filed on Apr. 23, 2024.

(51) Int. Cl. G06V 20/70; G06T 17/00; G06V 10/44; G06V 10/82; G06V 20/10

(52) U.S. Cl. CPC G06V 20/70; G06T 17/00; G06V 10/44; G06V 10/82; G06V 20/188

(57) ABSTRACT

A method useful in agricultural applications such as crop row following involves automatically generating annotations for training machine learning models by performing steps of accessing recorded geospatial data indicating positions related to agricultural field elements, acquiring image data of an agricultural field from a depth sensing camera, generating a three-dimensional point cloud from the image data using depth information, determining spatial relationships between points in the point cloud and the positions indicated in the recorded geospatial data, identifying pixels in the image data that correspond to features of interest based on the determined spatial relationships, and generating annotation data by marking the identified pixels as belonging to the features of interest.

### RELATED APPLICATIONS

This application claims priority to U.S. Provisional Patent Application No. 63/637,605, filed Apr. 23, 2024, and entitled “Automatic Annotation of Data for Machine Learning”, hereby incorporated by reference in its entirety.

### BACKGROUND OF THE INVENTION

### Field of the Invention

The present disclosure relates generally to machine learning and, more particularly but not exclusively, to systems and methods for automatically generating annotated image or video data using positional and sensor data for training neural networks without requiring extensive human labor such as may be used in agricultural guidance systems.

### Background

Training modern machine learning models such as neural networks require vast amounts of accurately annotated data. Manual annotation, particularly in domains such as semantic segmentation and object detection, is time-consuming, costly, and often infeasible at scale.

Although the present disclosure is not necessarily limited to agricultural, additional challenges are present in agricultural applications. Therefore, the background is discussed in the agricultural context. In modern agriculture, there is growing interest in using machine learning—particularly neural networks—for tasks such as row detection, weed identification, plant health monitoring, and obstacle avoidance. However, one of the principal challenges in deploying these models is acquiring the large volume of annotated image data required for training. In many agricultural contexts, the features of interest—such as crop rows, weeds, or obstructions—are not reliably detectable through automated image processing without first training a model, yet generating training data requires these same features to be labeled in large numbers of images. Unlike domains where objects are easily labeled with existing datasets or consistent visual cues, agricultural features are often field-specific, equipment-dependent, or vary over the growing season. As a result, each use case may require its own bespoke dataset, making manual annotation economically and logistically impractical. Furthermore, manually labeling image data at the pixel level-particularly for tasks such as semantic segmentation-requires both technical knowledge and field-specific expertise, further limiting scalability. Thus, there is a need for systems and methods that can automatically annotate agricultural image data using data that is already collected during routine field operations, such as GPS-logged implement paths or known equipment configurations.

### SUMMARY OF THE INVENTION

Therefore, it is a primary object, feature, or advantage of the present disclosure to improve over the state of the art by providing a method for automatically generating annotated image data suitable for training machine learning models without requiring manual labeling of image features.

Another object, feature, or advantage of the present disclosure is to reduce the cost, time, and labor associated with creating annotated training datasets for machine learning in agricultural applications.

A further object, feature, or advantage of the present disclosure is to leverage positional data from field equipment—such as GPS-logged planter row positions—to identify and annotate features of interest within image data captured at a later time.

A still further object, feature, or advantage of the present disclosure is to generate pixel-level semantic segmentation masks by projecting per-pixel depth data from images into a global coordinate system and comparing it to known feature positions.

Yet another object, feature, or advantage of the present disclosure is to enable dynamic or operator-calibrated classification thresholds that allow for flexible and accurate annotation under varying field conditions.

Still another object, feature, or advantage of the present disclosure is to reduce reliance on expensive or complex sensors at inference time by enabling models to be trained using data gathered with such sensors, but later deployed using simpler camera-only systems.

An additional object, feature, or advantage of the present disclosure is to provide a method compatible with a wide range of agricultural features, including but not limited to crop rows, weeds, terrain features, or known obstructions.

Yet another object, feature, or advantage is to combine positional logging with spatial image projection techniques to produce accurate, scalable annotations without human labeling.

A further object, feature, or advantage of the present disclosure is to support improved precision agriculture capabilities, including automated guidance, targeted chemical application, and machine vision-based obstacle avoidance, by facilitating scalable training of machine learning models.

One or more of these and/or other objects, features, or advantages will become apparent from the specification and claims that follow. No single embodiment needs to have or provide each and every object, feature, or advantage as different embodiments may have different objects, features, or advantages.

According to one aspect, a method for automatically generating annotations for training machine learning models includes accessing sensor-recorded position data indicating reference locations associated with features of interest in an environment. The method further includes acquiring image data of the environment from a depth sensing camera. The method further includes generating a three-dimensional point cloud from the image data using depth information. The method further includes determining spatial relationships between points in the point cloud and the reference locations indicated by the sensor-recorded position data. Th method further includes identifying pixels in the image data that relate to the features of interest based on the determined spatial relationships. The method further includes generating annotation data by marking the identified pixels as belonging to the features of interest. The step of accessing position data comprises: obtaining recorded location data from a first pass through the environment by an agricultural machine with at least one position sensor; and wherein acquiring image data comprises capturing images during a second pass through the environment at a subsequent time.

According to one aspect, a method for automatically generating annotations for training machine learning models includes accessing position data indicating locations of features of interest in an environment, acquiring image data from a depth sensing camera, generating a three-dimensional point cloud using depth information, determining correspondences between points in the point cloud and feature locations, identifying pixels in the image data related to these features based on the correspondences, and generating annotation data by marking the identified pixels as belonging to the features of interest. The method may further include obtaining recorded location data from a first pass through the environment by an agricultural machine with at least one position sensor, and capturing images during a second pass through the environment at a subsequent time. The method may further include calculating distances between each point in the point cloud and the locations of features of interest, and identifying points in the point cloud that are within a predetermined threshold distance of the locations of features of interest. The method may further include adjusting the predetermined threshold distance based on visual verification of the identified pixels. The method may further include features of interest comprising agricultural crop rows, and the position data indicating locations where planting occurred. The method may further include fitting continuous curves or lines between locations of features of interest to create a continuous representation, and determining correspondences between points in the point cloud and the continuous representation. The method may further include features of interest comprising at least one of: crop rows, space between crop rows, weeds, obstructions, hazards, washouts, puddles, or human-caused structures in an agricultural field. The method may further include using the annotation data to train a neural network to identify the features of interest in new images without requiring depth sensing information. The method may further include deploying the trained neural network on an agricultural vehicle to control operations of the vehicle based on visual identification of the features of interest.

According to another aspect, a method for automatically generating annotations to train machine learning models includes accessing position data indicating locations of agricultural field features captured by sensors on an agricultural machine during field operations, acquiring image data from a depth sensing camera mounted on an agricultural machine, generating a three-dimensional point cloud, determining correspondences between points in the point cloud and agricultural field feature locations, identifying relevant pixels in the image data, and generating annotation data for training a machine learning model for agricultural operations. The method may further include agricultural field features comprising planted crop rows, and the position data indicating locations where planting occurred by a planter. The method may further include determining a location of each planter box on the planter, calculating an offset from a sensor location to each planter box, and determining global coordinates for each planted row based on the planter box locations and offsets. The method may further include using the annotation data to train a neural network to perform row following operations based on visual data from a camera.

According to another aspect, a guidance system for an agricultural machine includes a camera mounted on the agricultural machine, a positioning system, a machine learning model trained using annotation data generated through a specific process, a processor that applies the model to identify agricultural field features without requiring depth sensing information and determines a guidance path, and a control system that controls movement according to the determined path.

According to another aspect, a system for automatically generating annotations for training machine learning models comprises a storage device storing position data, a depth sensing camera, and a processor configured to generate a three-dimensional point cloud, determine correspondences between points and feature locations, identify relevant pixels, and generate annotation data.

According to another aspect, a method for automatically generating annotation of data for machine learning models involves receiving position information associated with a feature of interest, receiving imagery associated with depth sensing, determining which pixels belong to the feature of interest, and outputting annotations sufficient to train a neural net.

According to another aspect, a method for automatically generating training data for machine learning models involves capturing image and position data from an agricultural machine, generating a three-dimensional point cloud, determining distances between points and features of interest, marking points below a threshold distance, projecting marked points onto the captured image data to generate pixel-level annotations, and outputting the data in a format suitable for training a machine learning model. The method may further include one or more features of interest comprising planted crop rows, the position sensors comprising sensors mounted on a planting implement, and the position data comprising positions of individual planter boxes during a planting operation. The method may further include fitting a continuous curve or line between known positions of the features of interest, and determining distances between points in the point cloud and the fitted curve or line rather than individual known positions.

According to another aspect, a method for generating annotated image data for training a machine learning model includes receiving logged feature positions in a global coordinate system, capturing an image using a depth-capable camera at a known pose, projecting pixels into three-dimensional points, identifying nearest logged feature positions, classifying points based on distance thresholds, and generating pixel-level annotations by assigning labels to classified points. The method may further include logged feature positions corresponding to locations of row units on an agricultural implement. The method may further include locations of the row units being determined by applying fixed spatial offsets to a reference position on the agricultural implement, and the reference position being determined using a global navigation satellite system (GNSS) receiver.

According to another aspect, a method for automatically generating annotations for training machine learning models is provided. The method includes accessing, by a computing device, recorded geospatial data indicating positions related to agricultural field elements. The method further includes acquiring image data of an agricultural field from a depth sensing camera. The method further includes generating, using one or more processors, a three-dimensional point cloud from the image data by processing depth information. The method further includes determining, using the one or more processors, spatial relationships between points in the point cloud and the positions indicated in the recorded geospatial data. The method further includes identifying, using the one or more processors, pixels in the image data that correspond to features of interest based on the determined spatial relationships. The method further includes generating annotation data by marking the identified pixels as belonging to the features of interest, wherein the annotation data is in a format suitable for training a machine learning model to identify the features of interest in subsequent images.

According to another aspect, a guidance system for an agricultural machine is provided. The guidance system includes a camera mounted on the agricultural machine to acquire image data of an agricultural field, a positioning system configured to determine a position of the agricultural machine, and a machine learning model stored in a memory, wherein the machine learning model is trained using annotation data generated by: accessing recorded geospatial data indicating positions related to agricultural field elements, acquiring training image data of the agricultural field from a depth sensing camera, generating a three-dimensional point cloud from the training image data using depth information, determining spatial relationships between points in the point cloud and the positions indicated in the recorded geospatial data, identifying pixels in the training image data that correspond to features of interest based on the determined spatial relationships, and marking the identified pixels as belonging to the features of interest. The guidance system further includes a processor configured to: receive the image data from the camera, apply the machine learning model to the image data to identify features of interest in the image, and determine a guidance path for the agricultural machine based on the identified features of interest. The guidance system may further include a control system configured to control movement of the agricultural machine according to the determined guidance path. The features of interest may include any number of features such as crop rows or spacing between crop rows. The recorded geospatial data my indicate locations where planting of seed occurred. The features of interest may also include weeds, obstructions, hazards, berms (from a tiling operation), washouts, puddles, or human-caused structures in the agricultural field. The recorded geospatial data may be obtained from sensors mounted on an agricultural implement or vehicle, and indicates positions where the implement performed operations in the agricultural field. The control system may be further configured for controlling an agricultural operation based on the identified features of interest such as, for example, activating spray nozzles.

According to another aspect, a method for automatically generating annotations for crop row following applications is provided. The method includes accessing recorded planting position data captured by positioning sensors mounted on a planting implement during a planting operation, wherein the planting position data indicates where row units deposited seeds in an agricultural field. The method further includes capturing image data of the agricultural field after crop emergence using a depth sensing camera mounted on an agricultural vehicle. The method further includes generating a three-dimensional point cloud from the image data using depth information. The method further includes creating a continuous representation of expected crop rows by fitting curves to the recorded planting position data. The method further includes determining spatial relationships between points in the point cloud and the continuous representation of expected crop rows. The method further includes identifying pixels in the image data that correspond to actual crop rows based on the determined spatial relationships. The method further includes generating annotation data by marking the identified pixels as belonging to crop rows. The method further includes training a neural network using the image data and the annotation data to enable the neural network to identify crop rows in subsequent images without requiring depth information.

### BRIEF DESCRIPTION OF THE DRAWINGS

FIG. 1 is one example of a flow diagram according to methods of the present disclosure.

FIG. 2 is a further example of a flow diagram according to methods of the present disclosure.

FIG. 3 is a further example of a flow diagram according to methods of the present disclosure.

FIG. 4A illustrates how each row position of a planting implement is derived from a known implement position.

FIG. 4B shows the positions of each row over time as the implement moves through the field.

FIG. 4C demonstrates how pixel data from an image is projected into a 3D point cloud. and how the distance to the nearest logged row position is calculated.

FIG. 4D demonstrates how the distance to the nearest logged row position is calculated.

FIG. 4E displays an annotated image generated from the 3D point cloud and known row positions.

FIG. 5 is a block diagram illustrating one example of a system.

### DETAILED DESCRIPTION

The present disclosure relates to systems and methods for automatically generating annotated training data for machine learning models. In particular, embodiments described herein enable the creation of pixel-level annotations for image data by leveraging additional sensor data during an initial data collection phase. This approach dramatically reduces the human labor typically required to create training datasets for computer vision models.

The present disclosure emphasizes the use in agricultural and agricultural guidance; however, the present disclosure may be used in other applications. However, the agricultural context may face additional problems not found in other applications and additional complexity not found in other applications and thus the methods described are particularly well-suited for agricultural applications.

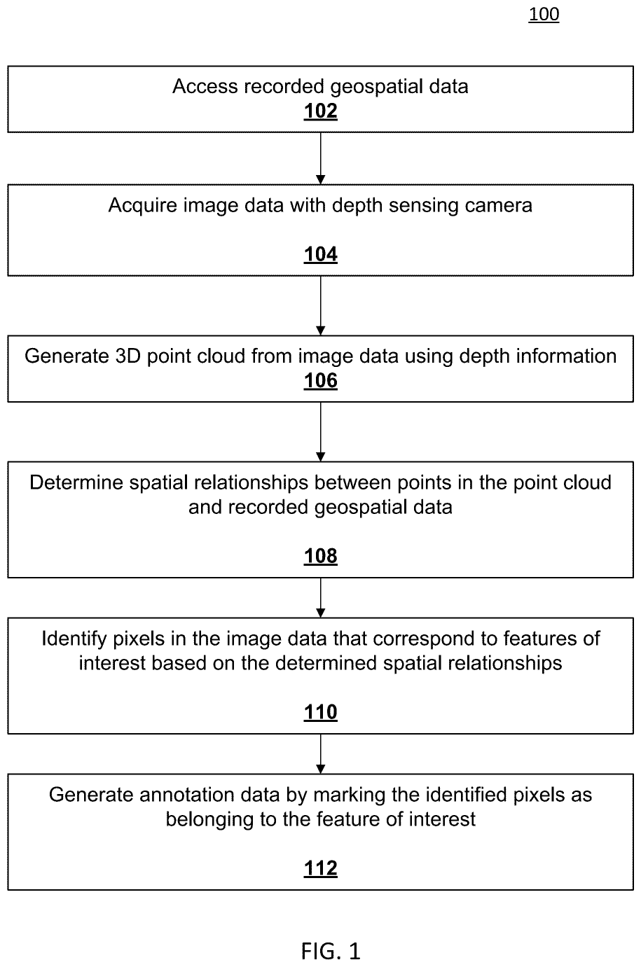

FIG. 1 is a flow chart illustrating an overview of a method 100. In step 102, recorded geospatial data is accessed. The recorded geospatial data may, for example, be GPS data received during a first pass over a field. For example, the geospatial data may be location data for rows of a planter as will be discussed later herein. Generally, if a GPS position of a point on an agricultural implement such as planter or a point on an agricultural vehicle is known which tows the agricultural implement, then because the agricultural implement and/or agricultural vehicle has known geometry the specific position of rows may be determined. In some implementations a combined GPS/IMU (inertial measurement unit) is used to more accurately account for position information. Other methods may be used to provide the known locations.

Next in step 104, image data may be obtained with a depth sensing camera. This may, for example, be acquired after the emergence of plants in an agricultural field. It is to be understood that the term “depth sensing camera” includes a camera used in combination with or integrated with any per pixel depth measurement device. This may be used along with sufficient sensors to accurately locate its position as the vehicle drives through the previously planted rows. The depth sensing camera or imaging device may include depth-sensing capabilities through stereo cameras, structured light, time-of-flight sensing, or other depth measurement techniques.

Next, in step 106, a 3D point cloud may be generated using the image data with depth information. Then in step 108, the method may determine spatial relationships between points in the point cloud and the recorded geospatial data. Then in step 110, pixels in the image data may be identified which correspond to features of interest based on the determined spatial relationships from step 108. Finally, in step 112, annotation data may be generated by marking the identified pixels as belonging to the feature of interest which may, for example, be a plant within a row, spacing between rows, or other feature of interest.

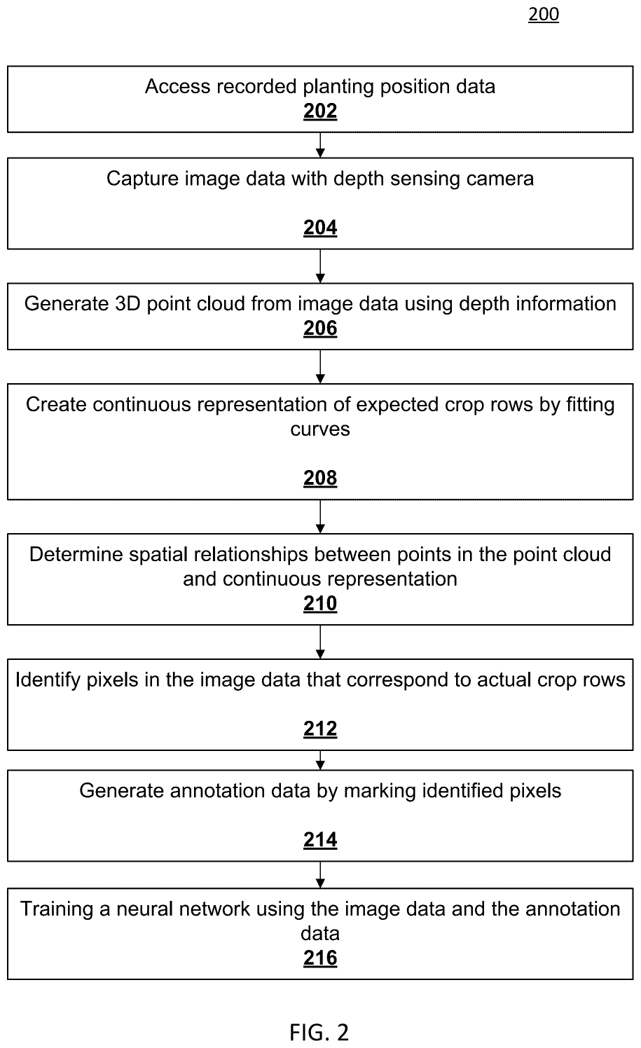

FIG. 2 illustrate a method 200 in more detail for a specific application of crop row following. In step 202, recorded planting position data is accessed. In step 204, image data is captured with a depth sensing camera. In step 206, a 3D point cloud is generated from image data using the depth information form the depth sensing camera. In step 208, a continuous representation of expected crop rows may be created by fitting lines or curves to points.

In step 210, spatial relationships are determined between points in the point cloud and the continuous representation. In step 212, pixels in the image data are identified that correspond to actual crop rows. In step 214, annotation data is generated by marking identified pixels as being part of the feature of interest which in this instance is the crop row. Then in step 216, training a neural network is performed using the image data and the annotation data.

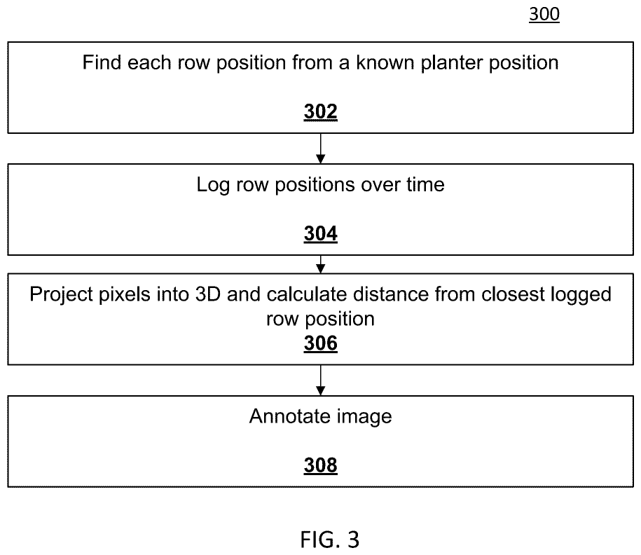

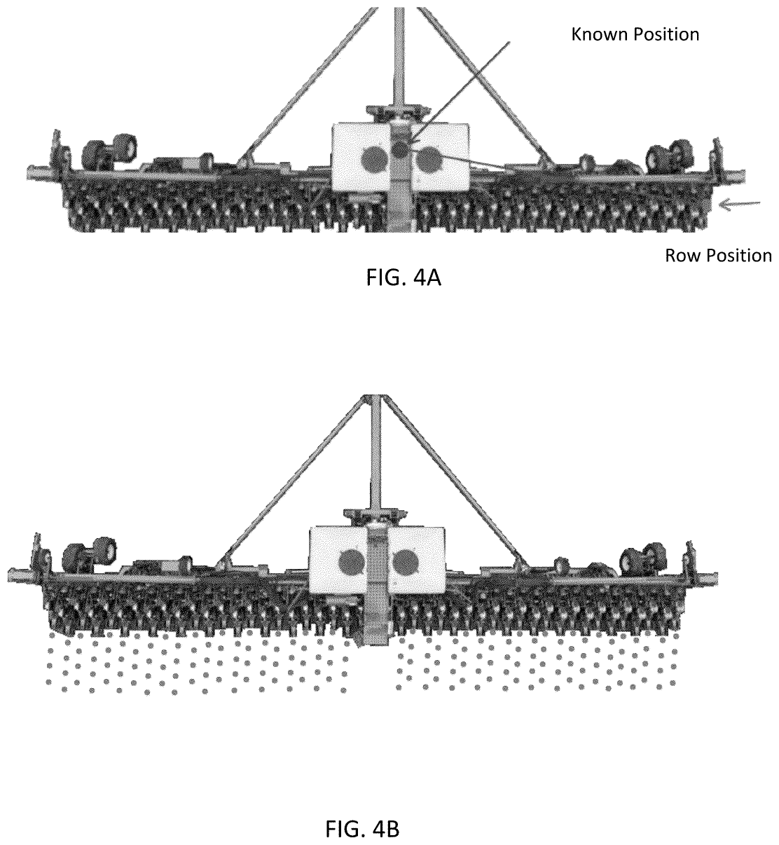

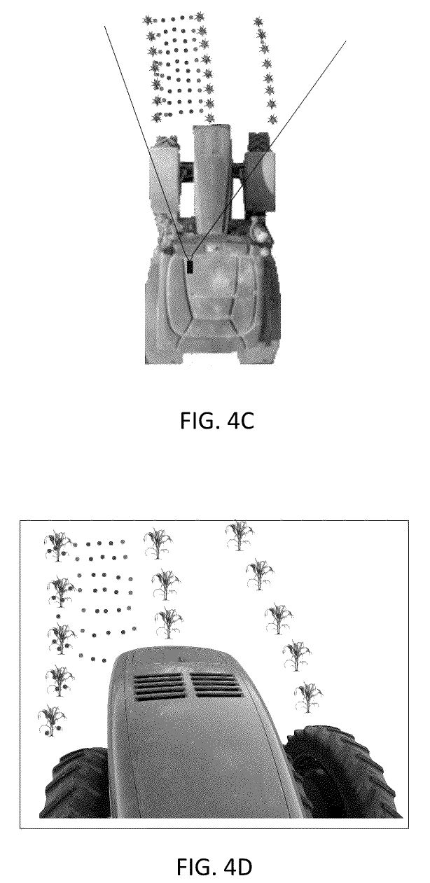

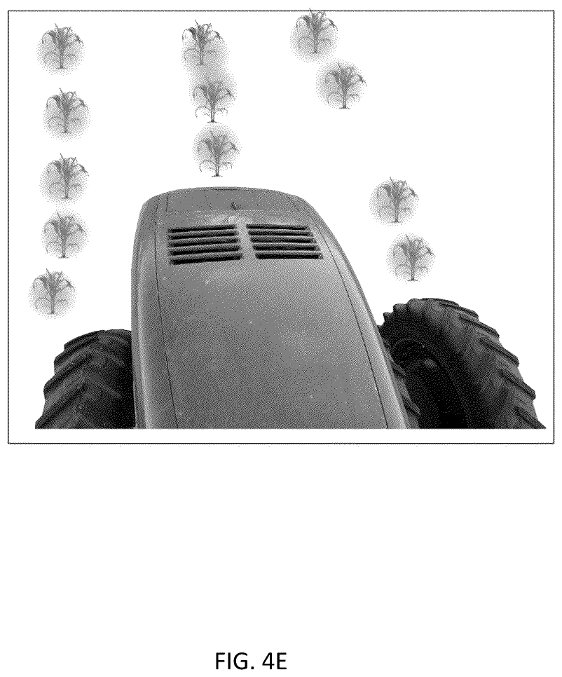

FIG. 3 and FIG. 4A, 4B, 4C, 4D, 4E further illustrate the method as applied in a particular context.

The location of rows of plants and the space between them can be found with high accuracy by placing any sensors between either or both the tractor and the pulled planting implement that highly accurately locates some point on the planter. Each row and the space between rows can then be calculated by measuring the offset from the part of the planter with a known location to each of the rows of the plater. Later in the season, a vehicle with a camera combined with any per pixel depth measurement device and sufficient sensors to accurately locate its position drives through the previously planted rows. The camera's location relative to the vehicle is known and calibrated for both its translational offset and its rotational offset. The combination of camera and location data allows each image of the video or other imagery captured to be matched with a location. Once recorded, the process may be run live as the vehicle drives through the field or at any later period by playing back the imagery with the attached data to provide for annotation.

Each image with its combined location at time of capture can be converted into a 3D global position for each pixel in that image. The result is each image can be converted into a point cloud on the terrain where each point is a location that can be compared to the previously logged planter location.

Then, a determination of which points in the point cloud correspond to the desired feature may be made. For example, which points represent the planted rows. The location of each planter box on the planter implement may be located in global coordinates by combining the global location of the overall implement with measurements from the sensor location to each planter box. The distance between each point in the point cloud and all the global planter box points may be calculated. The global planter box point found to be the closest to the currently selected point from the point cloud may then be paired with the currently selected point from the point cloud. If the two points are sufficiently close, meaning within a set threshold, that point is declared part of the planted row. As the plants grow this threshold may be adjusted. By playing back this data, a single person may manually adjust these thresholds until the points in the point cloud that are declared as part of the row appear visually accurate. This small calibration procedure is advantageous over manually marking every pixel of every image. Further, enhancement may be made when specifically locating rows. Curves or lines may be fit between the planter row locations to create a more continuous representation of the rows. Each point in the point cloud may be paired with the closes point on the continuous curve or line and the algorithm may continue. This enhancement eliminates error where points from the point cloud fall between planter sensor location updates and report a further distance from the row. Next this point cloud is projected back into the image for the purpose of annotation. Each point in the point cloud for each image keeps track of its originating pixel during the distance comparison portion above. When the point in that point cloud is marked as part of the desired feature, meaning part of the plant row in this example, the pixel in the original image is also marked. Marking each pixel that is part of the row generates exactly the mask annotation that semantic separation requires. The text describing this feature may be set prior to running the process. The end result are annotations for the entire video or set of imagery painting the position of the feature or features of interest and in the annotation output form required by a neural network or other machine learning model.

FIG. 3 illustrates a method 300. In step 302, each row position is found from a known planter position. The positions of agricultural implements or their components may be tracked with high spatial accuracy during field operations. As illustrated in FIG. 4A, during a planting operation, a reference position on the planter implement is tracked using high-accuracy localization sensors such as real-time kinematic (RTK) GPS or other GNSS-based positioning systems. Each row unit on the planter is at a known and fixed offset from this reference position, and the position of each planter row can thus be calculated in global coordinates for each position update of the reference point.

In step 304 of FIG. 3, row positions are logged over time. Over time, as the implement traverses the field, a set of global coordinates is generated corresponding to each row unit's path. These paths are shown, for example, in FIG. 4B, where the positions of each planter row are recorded at discrete time intervals, forming a spatial log of the row layout. This positional information is preserved and made available for later use in annotating imagery.

Subsequently, a vehicle is driven over the same field. This vehicle is equipped with a camera system that includes a depth-sensing capability. The depth sensor may be a stereoscopic camera, a time-of-flight sensor, or any other device capable of generating a per-pixel depth map of the captured image. The position and orientation (pose) of the camera relative to the vehicle's global position are known and calibrated. As the vehicle moves through the field, it records images or video frames synchronized with localization and orientation data. At the moment of image capture, the depth map and pose information are used to project each pixel in the image into a three-dimensional (3D) point in global space. The result is a dense 3D point cloud corresponding to the terrain visible in the image frame.

In step 306 of FIG. 3, pixels are projected into 3D and distances are calculated from the pixels to the closest logged row position as also shown in FIG. 4C. In this projected point cloud, the original pixel coordinates are preserved alongside the global spatial coordinates. The method proceeds by comparing each point in the point cloud to the previously recorded feature positions—in this example, the planter row paths from the earlier field operation. As shown in FIG. 4D, for each point in the point cloud, the system calculates its Euclidean distance to the nearest logged row position. If the distance falls within a predetermined threshold, the point is classified as part of the corresponding planted row. The threshold distance may be user-defined or calibrated through a brief manual review of the projected images. In some embodiments, the threshold can be adjusted dynamically depending on crop growth stage or row visibility.

To enhance continuity and compensate for spacing between logged GPS positions, the row paths may be interpolated or fit to continuous curves. This refinement reduces classification error caused by minor drift or point density mismatches. By fitting splines, polynomials, or other regression curves to the discrete planter box positions, a continuous spatial model of the row layout is obtained.

Thus, curves or lines can be fit between the planter row locations to create a more continuous representation of the rows such as disclosed in U.S. patent application Ser. No. 19/041,825, hereby incorporated by reference in its entirety. Given any series of points in an image, points may be correlated to some feature, and the location of the feature to which they correspond be stored in an alternative manner than merely saving out the pixels for the feature or the points. For example, the points may correspond to the center of a row of corn plants. Instead of storing the pixel locations which would constitute multiple points per row, one may instead store the coefficients of a straight line, whose equation may be written as y=mx+b, thereby reducing the amount of storage space from any number of elements along the line to 2 (i.e., just the slope and y-intercept of each line). An added benefit of storing the data in this manner is that the entirety of a crop row is identified. This allows one to interpolate along a smoother line when querying a point between two of the originally identified points as opposed to having what would be a noisier interpolation if only the two closest points were used.

Similarly, in the event that plants or features are missing, since the best fit line is continuous, one may interpolate the data along each row in equally spaced and uniform manner. This would be particularly useful as the step-size/distance between points may be selected based on the application. For example, if one were trying to combine information from each row in such a way as to make a central guidance line, and that guidance line needed to be set as a series of way points, then the continuous nature of the best fit line would allow the spacing between way points may be set to any value/distance.

Thus, as described above, continuity may be enhanced and spacing between GPS positions logged may be compensated for including in the context of crop row paths.

Each point in the point cloud may then be compared to the nearest location along the continuous row curve rather than to individual logged points. This approach improves annotation accuracy, especially when the row paths curve or diverge slightly due to terrain or implement drift.

Once classification is complete, each point in the point cloud that has been identified as corresponding to a feature of interest is mapped back into the image frame using the original pixel association. This projection step results in an annotated image in which the pixels corresponding to the detected feature are labeled. In FIG. 3, step 308, the image is annotated. In the case of semantic segmentation, this process yields a binary or multi-class mask in which each pixel is labeled according to its feature category. An example of such an annotated image is shown in FIG. 4E, where crop rows are identified and marked in the image based on the prior geolocation data and the computed proximity of the point cloud data to those logged positions.

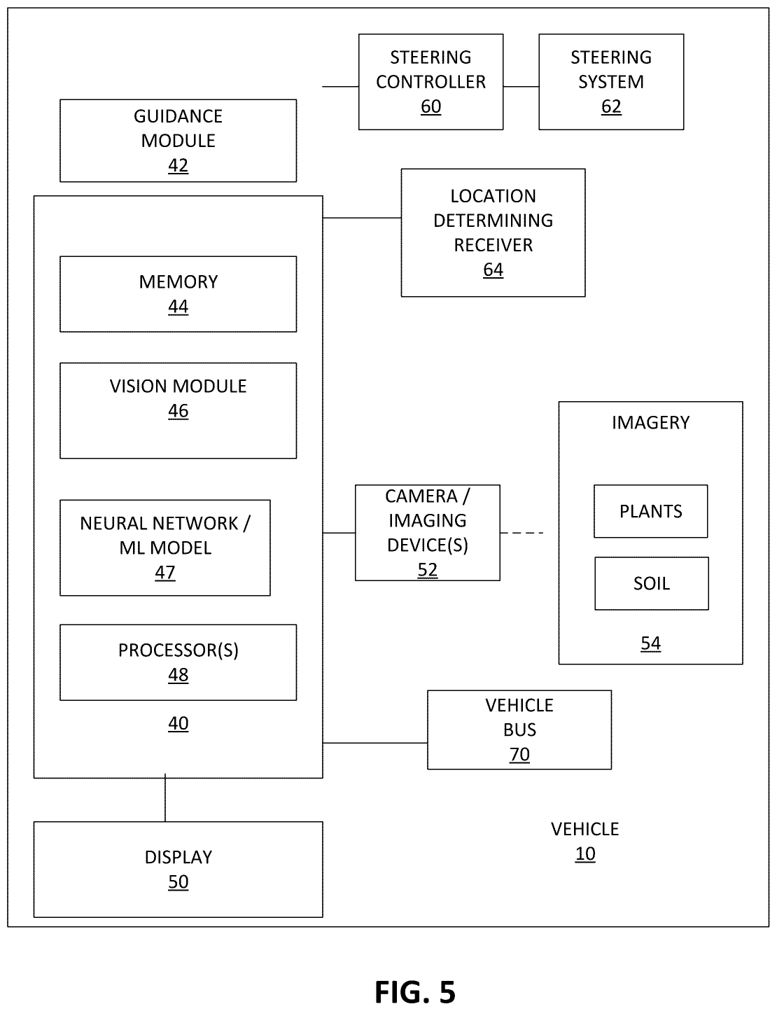

FIG. 5 illustrates one example of a system which includes a vehicle 10. A vehicle 10 may be associated with an implement. The vehicle 10 has a control system 40. The control system 40 may include a guidance module 42, a memory 44, a vision module 46, and one or more processors 48. A neural network or other machine learning model 47 may be accessible by the control system and may be in communication with the vision module 46, and the guidance module 42.

A camera or imaging device 52 is shown which is operatively connected to the control system. The camera or imaging device 52 may be mounted to the vehicle or an implement associated therewith. The camera or imaging device may acquire imagery 54 which may be of an agricultural field and include plants and/or soil within the field as well as any other features of interest.

A location determining receiver 64 is also shown and is operatively connected to the control system 40. The location determining receiver may include a GPS receiver or other geolocation or positioning system which may or may not be augmented such as with an inertial measurement unit (IMU). To provide for automated steering of the vehicle 10, a steering control 60 may be operatively connected to the control system 40 and the steering controller 60 may be used to control a steering system 62. A vehicle bus 70 is also shown which is operatively connected to the control system as in some embodiments, steering commands, sensor information, or other communications may be communicated over a vehicle bus 70 throughout the vehicle 10. A display 50 is also shown which is operatively connected to the control system and may be a touch display to allow for displaying information to a user or receiving input from the user. Of course, other types of user interfaces may be used as may be appropriate for a particular application or environment.

Thus, the system shown in FIG. 5 allows for guidance of the vehicle. The neural network is trained to locate features of interest such as crop rows and gaps between crop rows. The neural network may then mark each pixel from an image generated by the camera or imaging device 52 which is mounted on the vehicle 10 as it drives through a field, including fields which were not a part of the original data collection. Each pixel may be converted to global positions and finally processed into a guidance line. The methodology described in U.S. patent application Ser. No. 19/057,707, filed Feb. 19, 2025, entitled “PROJECTING PIXELS ONTO TERRAIN” is hereby incorporated by reference in its entirety and is one example illustrating conversion of pixels to global positions.

To do so, a set of dynamic inputs are obtained. The dynamic inputs include pixel coordinates, vehicle position, and vehicle angles. The pixel coordinates include an x-position (X_{P}), y-position (Y_{P}), and depth (D). The X and Y pixel coordinates represent the center of the specific feature or interest. The vehicle position includes X, Y, and Z in global coordinates such as geodetic coordinates. The Vehicle Angles include roll, pitch, and yaw in vehicle, Euler, global, or other coordinates.

It is to be understood that any number of different methods may be used for identifying a feature and/or determining that a feature is of interest. This may include methodologies such as thresholding, edge detection, feature detection and description algorithms, region-based segments, morphological operations, histogram analysis, texture analysis, machine learning algorithms such as deep learning, neural networks such as convolutional neural networks, or other types of neural networks or machine learning algorithms. The type of algorithms used may depend upon the type of environment, the type of features of interest, or other contexts or constraints.

Depth can be determined in various ways. For example, stereography or stereo vision may be used where multiple cameras are present (or a single camera provides stereo vision) in order to estimate distance to a feature of interest based on the difference in position of the feature of interest between images from the multiple cameras. Single cameras which provide depth sensing may be referred to as stereo cameras or 3D cameras and such cameras include multiple sensors and calculate depth information.

Time-of-flight (ToF) cameras may also be used to measure depth. The ToF camera may measure the time it takes for light (often infrared light) to travel from a camera to a feature of interest and back thereby allowing for calculation of a distance (depth) to the feature-of interest.

Light Detection and Ranging (Lidar) may be used for depth sensing. Lidar systems emit laser pulses and measure the time it takes for the light to be reflected back thereby allowing for depth to be determined.

Depth estimation may be used. For example, it is also contemplated that depth estimation may be performed such as monocular depth estimates where a machine learning model is trained to infer depth from image content and/or other available information. The machine learning model may be trained based on data from the same or similar application, the same or similar field, the same or similar camera, or otherwise under the same or similar conditions to otherwise provide the most effective machine learning model.

The vehicle position may be determined based on data from a geolocation receiver such as a GPS receiver. In addition, vehicle angles may be determined based on information from the GPS receiver, measurements from an inertial measurement unit (IMU), or a combination of GPS data and IMU data. Other sensors may also be used such as optic flow sensors, load cells, strain gauges, encoders, various angle sensors, etc. to obtain the vehicle's roll and pitch in combination with or instead of an IMU.

Camera calibration inputs are also obtained including for translation calibration (Xc, Yc, Zc), angular calibration including Φ_{c}(roll), Θ_{C}(pitch), Ψ_{C} (yaw), camera resolution (R), cameral focal length (F), physical size of an image sensor, and pixel size, Ps. The camera translation calibration is a measurement from a point on the vehicle with a known global position to the position of the camera. The camera angular translation is the roll, pitch, and yaw offset of the camera relative to the vehicle. The camera resolution is the pixel width and pixel height of the output image, such as 1920×1080 or 4 k. The camera focal length describes the distance from the lens where the image converges. The camera pixel size is the physical size of each of the square image sensors which represent each pixel in the output image.

A pixels to angles operation is performed. Pixel coordinates (X_{P}, Y_{P}) are used along with the cameral resolution, R, the camera focal length, F, and the pixel size, Ps, to determine a width angle and a height angle.

This sub-process combines the pixel coordinates with the resolution, focal length, and pixel size to generate an angle from the camera. Note: The following equation may change in sign depending on the location of the origin, (0, 0), in the image.

$${Pixel}_{width} = {P [ ( \frac{{R}_{width}}{2} ) - {X}_{p} ]}_{s}$$

$${Pixel}_{height} = {P}_{s} [ ( \frac{{R}_{height}}{2} ) - {Y}_{p} ]$$

$${Angle}_{width} = 2 {tan}^{- 1} [ \frac{{Pixel}_{width}}{2 F} ]$$

$${Angle}_{height} = 2 {tan}^{- 1} [ \frac{{Pixel}_{height}}{2 F} ]$$

Next, angles are converted to a 3D vector in camera space. In addition to the width angle and the height angle, the depth, D, is used. This sub-process executes a change of coordinate system which shifts the 3D vector from reference of the center of the camera to reference of the forward facing direction of the vehicle and to the origin which is the point on the vehicle with known global coordinates. Note: R in the following equations denotes the standard 3D rotation matrix.

$$[ \begin{matrix}{X}_{v} \\ {Y}_{v} \\ {Z}_{v}\end{matrix} ] = R ( {Φ}_{c} , {Θ}_{C} , {Ψ}_{C} ) \cdot [ \begin{matrix}{X}_{S} \\ {Y}_{S} \\ {Z}_{S}\end{matrix} ] + [ \begin{matrix}{X}_{C} \\ {Y}_{C} \\ {Z}_{C}\end{matrix} ]$$

Once the 3D vector (Xs, Ys, Zs) has been obtained in step 14, in step 16 the 3D vector along with the translation calibration (Xc, Yc, Zc), angular calibration including Φ_{c}(roll), Θ_{C(pitch)}, Ψ_{C}(yaw) are used to determine the 3D vector in vehicle space from the 3D vector in camera space. Thus, the vector Xᵥ, Yᵥ, Zᵥ is obtained.

The sub-process converts the 3D vector pointing from the vehicle to the feature of interest into a global coordinate position of the feature. The process may include any form of global position, but the following shows by example converting to geodetic GPS coordinates.

To reach the geodetic coordinate we first define a Local Tangent Plane. This plane assumes the curvature of the earth is small enough over the relatively small operating distances, a few square miles, to simplify converting vectors into geodetic coordinates.

Here, the process rotates the vehicle space vector into LTP space and shifts the origin from the location on the vehicle where the global position is known to the origin of the LTP.

$$[ \begin{matrix}{X}_{ltp} \\ {Y}_{ltp} \\ {Z}_{ltp}\end{matrix} ] = R ( Φ , Θ , Ψ ) \cdot [ \begin{matrix}{X}_{v} \\ {Y}_{v} \\ {Z}_{v}\end{matrix} ] + [ \begin{matrix}X \\ Y \\ Z\end{matrix} ]$$

The 3D vector in a global coordinate system or global space is obtained from the 3D vector in vehicle space and using X, Y, Z, as well as the roll, pitch, and yaw. The process converts back from LTP to geodetic using well known methods such as the Newton-Raphson method. Thus, the output is the geodetic position of the input pixels associated with a feature of interest.

Thus, in this manner, the trained neural network model may be used as a part of a guidance system to allow for row following.

Another application of the methodologies shown and described is for targeted weed spraying. A group of agronomists, crop scouts, or others may walk a field and mark the positions and types of weeds throughout the field. Using the methods shown and described herein the field may be driven with a vehicle and mounted camera. The resulting imagery which may be video can be auto annotated to train a neural network to identify and locate the weeds in the field. With that neural network trained, further actuators can be added to sprayers to adjust sprayer operations to target specific weeds.

A further example of an application is obstruction avoidance. Similar to the method used for weed spraying, one may walk the field or otherwise identify obstructions in the field and a neural network may be trained to identify and locate obstructions within the field. The vehicle may then be adjusted to avoid obstructions which are identified with the trained neural network.

The system is particularly valuable in agricultural applications. For row following applications, the system can annotate crop row positions in image data, enabling the training of models to visually identify rows and enable autonomous guidance without requiring high-precision GPS. In weed control applications, operators can mark weed positions during scouting, and the system generates training data from subsequent imaging to train detection models for automated spraying. For obstacle avoidance, the system can record obstacle positions during field surveying and generate training data for obstacle detection, enabling autonomous obstacle avoidance.

In further examples, the portions of the field a plow has worked are similar to planted rows. The berm created by tile installation is also similar to the previous examples.

Beyond agriculture, the system can be adapted for various other applications, including mapping and annotating infrastructure features, identifying terrain features or hazards, tracking movable objects or equipment, and generating training data for any visually identifiable feature whose position can be independently measured.

The generated training data enables training of various types of machine learning models, particularly deep neural networks for computer vision tasks. This approach offers several key advantages. It dramatically reduces the human labor required for training data generation, provides highly accurate annotations through sensor measurements, is scalable to large datasets, adapts to various features and applications, and enables deployment of lower-cost systems after training. The system thus addresses one of the major bottlenecks in developing machine learning solutions—the creation of large, accurately annotated training datasets.

Although the example above focuses on annotating crop rows, spaces between crops, weeds, and obstacles within agricultural fields, the same methodology may be applied to a variety of agricultural and non-agricultural features. Any feature whose position can be determined through field operations or external data sources may be used in this annotation process. For example, the positions of weeds, obstructions, or terrain features may be manually logged by agronomists walking the field or by automated systems such as drones or satellite imaging. These logged positions can later be used as references to classify and annotate images collected during vehicle-mounted camera passes. For instance, if a particular weed species is geolocated, a vehicle can traverse the same area with a depth-sensing camera, and the same projection and distance-threshold method can be used to label the presence of the weed in captured images. Similarly, obstructions or hazards—such as rocks, ruts, or puddles—can be logged and later identified in imagery using the same technique.

Moreover, this method enables the training of vision-based neural networks. Once trained, the models can operate using camera input to infer the location of features such as crop rows, weeds, or obstructions. These trained models can then be deployed for tasks such as automatic row following, targeted chemical application, or obstacle avoidance. In the context of row following, the model receives a camera image and outputs the location of crop rows in image space. These image-space features can then be reprojected into global space using known camera pose and terrain information, providing guidance inputs to automated steering systems.

The foregoing disclosure provides illustration and description but is not intended to be exhaustive or to limit the implementations to the precise form disclosed. Modifications may be made in light of the above disclosure or may be acquired from practice of the implementations. As used herein, the term “component” or “module” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware may be used to implement the systems and/or methods based on the description herein. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more”. Further, as used herein, the article “the” is intended to include one or more items referenced in connection with the article “the” and may be used interchangeably with “the one or more”. Furthermore, as used herein, the term “set” is intended to include one or more items (e.g., related items, unrelated items, a combination of related and unrelated items, and/or the like), and may be used interchangeably with “one or more”. Where only one item is intended, the phrase “only one” or similar language is used. Also, as used herein, the terms “has”, “have”, “having”, or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or”, unless explicitly stated otherwise (e.g., if used in combination with “either” or “only one of”).

Although different embodiments or examples are provided it is to be understood that elements of different embodiments may be combined.

Where processes include a set of steps it is to be understood that the steps do not necessarily need to be performed in the order provided unless context expressly requires it in order for the process to be operational.

Although different embodiments or examples are provided it is to be understood that elements of different embodiments may be combined.

Where processes include a set of steps it is to be understood that the steps do not necessarily need to be performed in the order provided unless context expressly requires it in order for the process to be operational.

The disclosure is not to be limited to the particular aspects described herein. In particular, the disclosure contemplates numerous variations. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions may be made, which are within the intended spirit and scope of the disclosure.

What is claimed:

1. A method for automatically generating annotations for training machine learning models, comprising:
accessing recorded geospatial data indicating positions related to agricultural field elements;
acquiring image data of an agricultural field from a depth sensing camera;
generating a three-dimensional point cloud from the image data using depth information;
determining spatial relationships between points in the point cloud and the positions indicated in the recorded geospatial data;
identifying pixels in the image data that correspond to features of interest based on the determined spatial relationships; and
generating annotation data by marking the identified pixels as belonging to the features of interest.

2. The method of claim 1, wherein accessing recorded geospatial data comprises: obtaining position data from a first pass through the agricultural field by an agricultural machine with at least one position sensor; and wherein acquiring image data comprises capturing images during a second pass through the agricultural field at a subsequent time.

3. The method of claim 1, wherein determining spatial relationships between points in the point cloud and the positions indicated in the recorded geospatial data comprises: calculating distances between each point in the point cloud and the positions indicated in the recorded geospatial data; and identifying points in the point cloud that are within a predetermined threshold distance of the positions.

4. The method of claim 3, further comprising: adjusting the predetermined threshold distance based on visual verification of the identified pixels.

5. The method of claim 1, wherein the features of interest comprise agricultural crop rows, and the recorded geospatial data indicates locations where planting occurred.

6. The method of claim 1, further comprising: fitting continuous curves or lines between the positions indicated in the recorded geospatial data to create a continuous representation of the agricultural field elements; and determining spatial relationships between points in the point cloud and the continuous representation.

7. The method of claim 1, wherein the features of interest comprise at least one of: crop rows, space between crop rows, weeds, obstructions, hazards, washouts, puddles, or human-caused structures in the agricultural field.

8. The method of claim 1, further comprising: using the annotation data to train a neural network to identify the features of interest in new images without requiring depth sensing information.

9. The method of claim 8, further comprising: deploying the trained neural network on an agricultural vehicle to control operations of the vehicle based on visual identification of the features of interest.

10. The method of claim 1, wherein the depth sensing camera comprises a stereographic camera system that calculates depth for each pixel in the image data.

11. The method of claim 1, wherein the recorded geospatial data is obtained from sensors mounted on an agricultural implement, and indicates positions where the implement performed operations in the agricultural field.

12. The method of claim 1, wherein generating annotation data comprises: associating text descriptions with the marked pixels, wherein the text descriptions identify types of features represented by the marked pixels.

13. A guidance system for an agricultural machine, comprising:
a camera mounted on the agricultural machine to acquire image data of an agricultural field;
a positioning system configured to determine a position of the agricultural machine; a machine learning model stored in a memory, wherein the machine learning model is trained using annotation data generated by:
(a) accessing recorded geospatial data indicating positions related to agricultural field elements;
(b) acquiring training image data of the agricultural field from a depth sensing camera;
(c) generating a three-dimensional point cloud from the training image data using depth information;
(d) determining spatial relationships between points in the point cloud and the positions indicated in the recorded geospatial data;
(e) identifying pixels in the training image data that correspond to features of interest based on the determined spatial relationships; and
(f) marking the identified pixels as belonging to the features of interest;
a processor configured to:
(a) receive the image data from the camera;
(b) apply the machine learning model to the image data to identify features of interest in the image;
(c) determine a guidance path for the agricultural machine at least partially based on the identified features of interest; and
a control system configured to control movement of the agricultural machine according to the determined guidance path.

14. The guidance system of claim 13, wherein the features of interest comprise agricultural crop rows, and the recorded geospatial data indicates locations where planting occurred.

15. The guidance system of claim 13, wherein the features of interest comprise at least one of: crop rows, space between crop rows, weeds, obstructions, hazards, washouts, puddles, or human-caused structures in the agricultural field.

16. The guidance system of claim 13, wherein the recorded geospatial data is obtained from sensors mounted on an agricultural implement or vehicle, and indicates positions where the implement performed operations in the agricultural field.

17. The guidance system of claim 13, wherein the processor is further configured to use positioning data from the positioning system to determine the guidance path.

18. The guidance system of claim 13, wherein the control system is further configured for controlling an agricultural operation based on the identified features of interest.

19. The guidance system of claim 18, wherein controlling the agricultural operation comprises activating spray nozzles to target identified weeds.

20. A method for automatically generating annotations for crop row following applications, comprising:
accessing recorded planting position data captured by positioning sensors mounted on a planting implement during a planting operation, wherein the planting position data indicates where row units deposited seeds in an agricultural field;
capturing image data of the agricultural field after crop emergence using a depth sensing camera mounted on an agricultural vehicle;
generating a three-dimensional point cloud from the image data using depth information;
creating a continuous representation of expected crop rows by fitting curves to the recorded planting position data;
determining spatial relationships between points in the point cloud and the continuous representation of expected crop rows;
identifying pixels in the image data that correspond to actual crop rows based on the determined spatial relationships;
generating annotation data by marking the identified pixels as belonging to crop rows; and
training a neural network using the image data and the annotation data to enable the neural network to identify crop rows in subsequent images without requiring depth information.
